(19) United States
(12) Patent Application Publication
(10) Pub. No.: US 2015/0298698 A1
(43) Pub. Date: Oct. 22, 2015

(54) VEHICLE TRAVEL CONTROL DEVICE

(71) Applicants: Jonggap KIM, (US); Masaki MITSUYASU, (US); Rentaro KUROKI, (US); Takuya HIRAI, (US); Masaki MATSUNAGA, (US); Yasunari KIDO, (US); Takeaki SUZUKI, (US); Takayuki KOGURE, (US); Yukari OKAMURA, (US); Akihiro SATO, (US); Yusuke KINOSHITA, (US)

(72) Inventors: Jonggap KIM, Hadano-shi (JP); Masaki MITSUYASU, Kawasaki-shi (JP); Rentaro KUROKI, Susono-shi (JP); Takuya HIRAI, Susono-shi (JP); Masaki MATSUNAGA, Odawara-shi (JP); Yasunari KIDO, Hadano-shi (JP); Takeaki SUZUKI, Susono-shi (JP); Takayuki KOGURE, Susono-shi (JP); Yukari OKAMURA, Gotenba-shi (JP); Akihiro SATO, Nagoya-shi (JP); Yusuke KINOSHITA, Toyota-shi (JP)

(73) Assignee: TOYOTA JIDOSHA KABUSHIKI KAISHA, Toyota-shi, Aichi (JP)

(21) Appl. No.: 14/439,453

(22) PCT Filed: Oct. 31, 2012
(86) PCT No.: PCT/JP2012/078228

§ 371 Date: Apr. 29, 2015

(51) Int. Cl. B60W 30/18; B60W 10/02; B60W 10/06

(52) U.S. Cl. CPC B60W 30/18009; B60W 10/06; B60W 10/02; B60W 30/18072; B60W 30/18136

(57) ABSTRACT

A running control device of a vehicle includes an engine with a plurality of cylinders and a clutch separating the engine and wheels, the running control device of a vehicle controls and supplies the clutch a line pressure acquired by adjusting an output oil pressure of an oil pump, the running control device of a vehicle is configured to execute a neutral inertia running mode that is an inertia running mode performed while the engine and the wheels are separated and a cylinder resting inertia running mode performed by stopping operation in at least a part of the cylinders of the engine while the engine and the wheels are coupled, the line pressure is low while the neutral inertia running mode is performed as compared to while the cylinder resting inertia running mode is performed.

### TECHNICAL FIELD

The present invention relates to a running control device of a vehicle including a clutch separating an engine and wheels and particularly to a technique when a plurality of types of inertia running modes can be performed with different processes of canceling the inertia running mode.

### BACKGROUND ART

To extend a running distance of the inertia running mode and improve fuel consumption in a vehicle including a clutch separating an engine and wheels, it is conceivable that the vehicle is allowed to perform the inertia running mode with an engine brake force reduced when a predetermined condition is satisfied during a normal running mode performed by using the power of the engine while the engine and the wheels are coupled. For example, in Patent Document 1, a control device of a vehicle is proposed that releases a clutch during running of the vehicle to separate an engine and wheels for performing the inertia running mode (referred to as a neutral inertia running mode) on the condition of accelerator-off etc. In Patent Document 2, a control device of a vehicle is proposed that rests some of cylinders of the engine during running of the vehicle to reduce a pumping loss for performing the inertia running mode (referred to as a cylinder resting inertia running mode).

### PRIOR ART DOCUMENT

### Patent Documents

### Patent Document 1: Japanese Laid-Open Patent Publication No. 2002-227885

### Patent Document 2: Japanese Laid-Open Patent Publication No. 5-79364

### SUMMARY OF THE INVENTION

### Problem to be Solved by the Invention

Although a reduction in engine brake force is in common, the two types of the inertia running modes, i.e., the neutral inertia running mode and the cylinder resting inertia running mode, have significantly different embodiments with respect to whether a clutch is released or whether a cylinder is rested. This difference between embodiments leads to different procedures at the time of cancel of the inertia running mode (e.g., at the time of return from the inertia running mode to the normal running mode). For example, in the case of return from the neutral inertia running mode, the procedure includes engaging the clutch and then transmitting the power of the engine toward the wheels after determination of return. In the case of return from the cylinder resting inertia running mode, the procedure includes transmitting the power of the engine toward the wheels after determination of return. Since a step of engaging the clutch is included at the time of return from the neutral inertia running mode as described above, the power of the engine can promptly be transmitted toward the wheels at the time of return from the cylinder resting inertia running mode as compared to return from the neutral inertia running mode. The clutch generally has an engagement force (having the same meaning as a torque capacity) generated depending on an engagement pressure (hereinafter referred to as a clutch engagement pressure) supplied to the clutch by controlling a line pressure acquired by adjusting an output oil pressure of an oil pump. When the torque capacity (hereinafter referred to as a clutch torque) of the clutch is larger, a larger power (having the same meaning as a torque) can be transmitted. Therefore, a larger line pressure enables generation of a clutch torque required for transmitting a larger power. However, a large line pressure deteriorates the controllability of the clutch engagement pressure when the clutch is controlled toward engagement (i.e., when the clutch torque is raised from zero) and sudden engagement may increase an engagement shock. Therefore, if a uniform line pressure is used in the two different types of the inertia running modes, i.e., the neutral inertia running mode and the cylinder resting inertia running mode, without considering the difference between the procedures of return from the inertia running mode and the characteristics of oil pressure related to the control of the clutch as described above, a desired drive force may become difficult to acquire or the engagement shock of the clutch may be deteriorated at the time of return from the inertia running mode, and a driver (a user) may more easily have a feeling of strangeness. The problem as described above is unknown and no proposal has hitherto been made on giving consideration to the difference between the respective procedures at the time of return from the different types of the inertia running modes and the characteristics of oil pressure related to the control of the clutch so as to properly control the line pressure in preparation for the time of return during the respective types of the inertia running modes.

The present invention was conceived in view of the situations and it is therefore an object of the present invention to provide a running control device of a vehicle capable of preventing a driver from having a feeling of strangeness at the time of return from each of different types of inertia running modes.

### Means for Solving the Problem

To achieve the object, the first aspect of the invention provides (a) a running control device of a vehicle including an engine with a plurality of cylinders and a clutch separating the engine and wheels, the running control device of a vehicle controlling and supplying to the clutch a line pressure acquired by adjusting an output oil pressure of an oil pump, the running control device of a vehicle is configured to execute a neutral inertia running mode that is an inertia running mode performed while the engine and the wheels are separated and a cylinder resting inertia running mode performed by stopping operation in at least a part of the cylinders of the engine while the engine and the wheels are coupled, (b) the line pressure being low while the neutral inertia running mode is performed as compared to while the cylinder resting inertia running mode is performed.

### Effects of the Invention

Consequently, while a time lag exists before an actual value of a line pressure increases as a command value and therefore, the line pressure during the inertia running mode is desirably set in consideration of the line pressure required at the time of return, the line pressure is lowered during the neutral inertia running mode so as to ensure the controllability of the clutch engagement pressure supplied to the clutch when the clutch is controlled toward engagement at the time of return, and the engagement shock is suppressed. On the other hand, while the cylinder resting inertia running mode in which the clutch is originally engaged can promptly output a drive force (having the same meaning as a drive torque etc.) at the time of return, the line pressure can be made higher during running to raise the clutch torque and, even if a large power is immediately transmitted at the time of return, the clutch slipping can be prevented. Especially, while since the engine rotation speed during the cylinder resting inertia running mode is the same as that during the normal running mode performed by using the power of the engine with the engine and the wheels coupled, it is considered that a driver expects the acceleration performance at the time of return same as that of the normal running mode, the clutch torque can be increased during the cylinder resting inertia running mode to promptly output the drive force at the time of return and to respond to the driver's expectation. Contrarily, since the engine rotation speed is lowered during the neutral inertia running mode as compared to the normal running mode, a driver hardly has a feeling of strangeness even if the acceleration performance is different from that during the normal running mode. Therefore, the driver can be prevented from having a feeling of strangeness at the time of return from the respective different types of the inertia running modes, which are the neutral inertia running mode and the cylinder resting inertia running mode.

A certain time is required for engaging the clutch from a released state. On the other hand, if a clutch torque appropriate for a torque amount transmitted toward the wheels is ensured at the time of completion of the engagement, no clutch slip occurs. Therefore, since even when the line pressure is lowered during the neutral inertia running mode, the line pressure can sufficiently be raised to increase the clutch torque before the clutch is engaged, a clutch slip hardly occurs after completion of the engagement of the clutch. Therefore, during the neutral inertia running mode, the line pressure is lowered to put more importance on fuel consumption, thereby reducing a loss due to the oil pumps. Since the line pressure is controlled in accordance with the characteristics of the inertia running modes as described above, the improvement in fuel consumption and the prevention of clutch slipping during acceleration can be satisfied at the same time as a secondary effect.

The second aspect of the invention provides the running control device of a vehicle recited in the first aspect of the invention, wherein the running control device of a vehicle is configured to execute an engine brake running mode that is an inertia running mode performed without stopping operation in the cylinders of the engine while the engine and the wheels are coupled, and wherein the line pressure is high while the engine brake running mode is performed as compared to while the cylinder resting inertia running mode is performed. Consequently, while since the operation in the cylinders is not stopped, the drive force can more promptly be output at the time of return during engine brake running mode as compared to the cylinder resting inertia running mode, the line pressure can be made higher during the engine brake running mode as compared to the cylinder resting inertia running mode to prevent the clutch slipping at the time of return as is the case with the return from the cylinder resting inertia running mode. While since the engine rotation speed during the engine brake running mode is the same as that during the normal running mode, a driver expects the acceleration performance at the time of return same as that of the normal running mode, the clutch torque can be increased during the engine brake running mode as compared to the cylinder resting inertia running mode to promptly output the drive force at the time of return and to respond to the driver's expectation, as is the case with the return from the cylinder resting inertia running mode. Therefore, the driver can be prevented from having a feeling of strangeness also at the time of return from the engine brake running mode, as is the case with the different types of the inertia running modes, which are the neutral inertia running mode and the cylinder resting inertia running mode.

The third aspect of the invention provides the running control device of a vehicle recited in the first or second aspect of the invention, wherein the cylinder resting inertia running mode is an inertia running mode performed by stopping fuel supply to the engine while the engine and the wheels are coupled and by stopping operation of at least one of pistons and intake/exhaust valves of at least a part of the cylinders of the engine. Consequently, the cylinder resting inertia running mode is properly performed.

The fourth aspect of the invention provides the running control device of a vehicle recited in any one of the first to third aspects of the invention, wherein the neutral inertia running mode is an inertia running mode performed with fuel supply to the engine stopped to stop rotation, or an inertia running mode performed with the engine supplied with fuel and operated, while the engine and the wheels are separated. Consequently, the engagement shock of the clutch at the time of return is suppressed by lowering the line pressure during the neutral inertia running mode regardless of the presence/absence of the fuel supply to the engine.

### BRIEF DESCRIPTION OF THE DRAWINGS

FIG. 1 is a diagram for explaining a general configuration of a drive device included in a vehicle to which the present invention is applied, and is a diagram for explaining a main portion of a control system in the vehicle.

FIG. 2 is a diagram for explaining four running modes performed in the vehicle of FIG. 1.

FIG. 3 is a flowchart for explaining a main portion of the control operation of the electronic control device, i.e., the control operation for preventing a driver from having a feeling of strangeness at the time of return from the respective different types of the inertia running modes, which are the neutral inertia running mode and the cylinder resting inertia running mode.

FIG. 4 is a time chart when the control operation depicted in the flowchart of FIG. 3 is executed.

FIG. 5 is a flowchart for explaining a main portion of the control operation of the electronic control device, i.e., the control operation for preventing a driver from having a feeling of strangeness at the time of return from the respective different types of the inertia running modes, the flowchart executed in addition to the flowchart of FIG. 3.

FIG. 6 is a time chart when the control operation depicted in the flowchart of FIG. 5 is executed.

### MODE FOR CARRYING OUT THE INVENTION

In the present invention, preferably, the vehicle includes a transmission transmitting the power of the engine toward the wheels. The transmission is made up solely of an automatic transmission or of an automatic transmission having a fluid power transmission device. For example, this automatic transmission is made up of a known planetary gear automatic transmission, a synchronous meshing type parallel two-shaft automatic transmission that is a known synchronous meshing type parallel two-shaft transmission and that has gear stages automatically switched by a hydraulic actuator, a so-called DCT (Dual Clutch Transmission) that is a synchronous meshing type parallel two-shaft automatic transmission and that is of a type having two systems of input shafts, or a known belt type continuously variable transmission or a toroidal type continuously variable transmission, etc.

Preferably, the clutch may be any hydraulic engagement device capable of separating the engine and the wheels, including a brake in a broad sense. A vehicle including the transmission may use as the clutch a hydraulic friction engagement device making up a portion of the automatic transmission capable of being neutral.

Preferably, the engine is an internal combustion engine such as a gasoline engine and a diesel engine generating power from combustion of fuel, for example. Although the vehicle may include at least the engine as a drive force source, the vehicle may include another drive force source such as an electric motor in addition to the engine.

Preferably, the engine brake running mode generates an engine brake force with a rotation resistance such as a pumping loss and a friction torque from the driven rotation of the engine and the engine may be in a fuel cut (F/C) state in which fuel supply is stopped or may be in an operating state in which a predetermined amount of fuel is supplied as is the case with the idling state etc. Even if fuel is supplied, the engine brake force is generated from the driven rotation at a rotation speed corresponding to a vehicle speed etc.

Preferably, pistons and intake/exhaust valves can mechanically be stopped in the cylinder resting inertia running mode by disconnecting a clutch mechanism disposed between a crankshaft, the pistons and intake/exhaust valves, for example. With regard to the intake/exhaust valves, for example, if intake/exhaust valves of electromagnetic type etc. are used that can be controlled to open/close independently of the rotation of the crankshaft, the operation thereof may be stopped. Although appropriate stop positions of the intake/exhaust valves are positions where, for example, all the valves are in a closed valve state corresponding to that in compression strike, the stop positions are defined as needed, including stopping at positions where all the valves are in an opened valve state. If operation of some cylinders is stopped in the cylinder resting inertia running mode, the remaining cylinders have the pistons and the intake/exhaust valves operated in synchronization with the rotation of the crankshaft. For example, in the case of an eight-cylinder engine, only half of the cylinders, i.e., four cylinders, are rested while the remaining four cylinders are operated, or only six cylinders are rested while the remaining two cylinders are operated.

An example of the present invention will now be described in detail with reference to the drawings.

### First Example

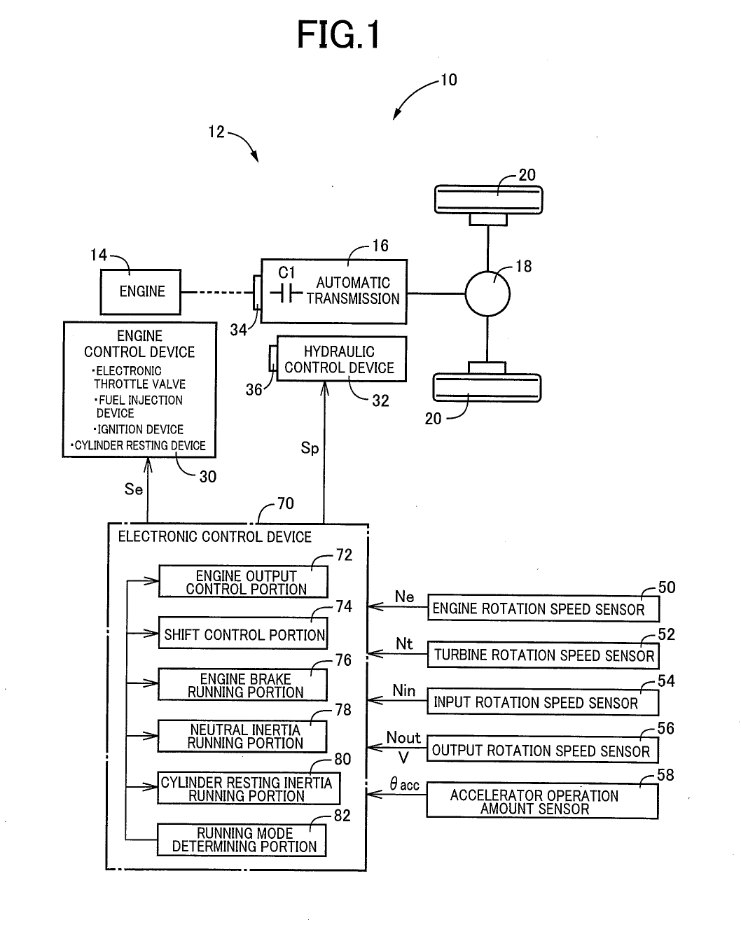

FIG. 1 is a diagram for explaining a general configuration of a drive device 12 included in a vehicle 10 to which the present invention is applied, and is a diagram for explaining a main portion of a control system for various controls in the vehicle 10. In FIG. 1, the drive device 12 includes an engine 14 with a plurality of cylinders, and an automatic transmission 16, and the power of the engine 14 acting as a drive force source is transmitted from the automatic transmission 16 via a differential gear device 18 to left and right wheels 20. For example, a damper device and a power transmission device such as a torque converter are disposed between the engine 14 and the automatic transmission 16, and a motor generator acting as a drive force source can also be disposed therebetween.

The engine 14 includes an engine control device 30 having various pieces of equipment necessary for output control of the engine 14, such as an electronic throttle valve, a fuel injection device, and an ignition device, and a cylinder resting device. The electronic throttle valve, the fuel injection device, and the ignition device control an intake air amount, a fuel supply amount, and ignition timing, respectively, and are basically controlled depending on an operation amount of an accelerator pedal (an accelerator operation amount) θacc corresponding to a drive demand amount for the vehicle 10 from a driver. The fuel injection device can stop the fuel supply (perform a fuel cut F/C) at the time of accelerator-off when the accelerator operation amount θacc is determined as being zero even during running of the vehicle. The cylinder resting device can mechanically separate intake/exhaust valves of some or all of multiple cylinders, for example, eight cylinders, from a crankshaft by a clutch mechanism etc. to stop the valves and, for example, all the intake/exhaust valves are stopped at positions where the valves are in a closed valve state. As a result, since a pumping loss is reduced when the engine 14 is driven to rotate at the time of the fuel cut F/C, an engine brake force is reduced and a running distance of an inertia running mode can be extended. The cylinder resting device may rest the cylinders, for example, by employing a form in which all the intake/exhaust valves are stopped in the opened valve state or by employing a form in which pistons are separated from the crankshaft and stopped instead of or in addition to the form in which the intake/exhaust valves are stopped.

The automatic transmission 16 is a stepped automatic transmission of a planetary gear type etc., having a plurality of gear stages with different gear ratios e established depending on engaged/released states of a plurality of hydraulic friction engagement devices (clutches and brakes). In the automatic transmission 16, each of the hydraulic friction engagement devices is subjected to engagement/release control by electromagnetic hydraulic control valves, switching valves, etc. disposed in a hydraulic control device 32 so that a predetermined gear stage is established depending on a driver's accelerator operation, a vehicle speed V, etc. A clutch C1 acts as an input clutch of the automatic transmission 20 and is a hydraulic friction engagement device subjected to the engagement/release control by the hydraulic control device 32 in the same way. The clutch C1 corresponds to a connecting/disconnecting device (clutch) connecting and disconnecting the engine 14 and the wheels 20. The automatic transmission 16 may be implemented by using a continuously variable transmission of a belt type etc., instead of a stepped transmission. The hydraulic control device 32 is supplied with an output oil pressure of at least one of a mechanical oil pump 34 and an electric oil pump 36 disposed on the vehicle 10 to adjust the output oil pressure to a line pressure. The hydraulic control device 32 controls the line pressure to supply the clutch engagement pressure to each of the hydraulic friction engagement devices including the clutch C1. Each of the hydraulic friction engagement devices has a clutch torque generated depending on each clutch engagement pressure and can transmit a larger torque when the clutch torque is larger. The mechanical oil pump 34 is rotationally driven by the engine 14 and outputs an oil pressure to the hydraulic control device 32. The electric oil pump 36 is rotationally driven by a motor to output an oil pressure to the hydraulic control device 32. Therefore, when the rotation of the engine 14 is stopped and an oil pressure is needed, the electric oil pump 36 is operated.

The vehicle 10 includes an electronic control device 70 including a running control device of the vehicle 10 related to the engagement/release control of the clutch C1, for example. The electronic control device 70 includes a so-called microcomputer including a CPU, a RAM, a ROM, and an I/O interface, for example, and the CPU executes signal processes in accordance with a program stored in advance in the ROM, while utilizing a temporary storage function of the RAM, to provide various controls of the vehicle 10. For example, the electronic control device 70 provides the output control of the engine 14, the shift control of the automatic transmission 16, the torque capacity control of the clutch C1, etc., and is configured separately as needed for the engine control, the hydraulic control, etc. The electronic control device 70 is supplied with each of various signals (e.g., an engine rotation speed Ne that is a rotation speed of the engine 14, a turbine rotation speed Nt that is a rotation speed of a turbine shaft of the torque converter, a transmission input rotation speed Nin that is an input rotation speed of the automatic transmission 16, a transmission output rotation speed Nout that is an output rotation speed of the automatic transmission 16 corresponding to the vehicle speed V, and the accelerator operation amount θacc) based on detection values from various sensors (e.g., an engine rotation speed sensor 50, a turbine rotation speed sensor 52, an input rotation speed sensor 54, an output rotation speed sensor 56, and an accelerator operation amount sensor 58). The electronic control device 70 outputs, for example, an engine output control command signal Se for the output control of the engine 14, an oil pressure command signal Sp for the engagement control of the clutch C1 and the shift control of the automatic transmission 16 to the engine control device 30 and the hydraulic control device 32, respectively.

The electronic control device 70 functionally includes an engine output control means, i.e., an engine output control portion 72, a shift control means, i.e., a shift control portion 74, an engine brake running means, i.e., an engine brake running portion 76, a neutral inertia running means, i.e., a neutral inertia running portion 78, a cylinder resting inertia running means, i.e., a cylinder resting inertia running portion 80, and a running mode determining means, i.e., a running mode determining portion 82.

The engine output control portion 72 outputs to the engine control device 30 the engine output control command signals Se controlling opening/closing of the electronic throttle valve, controlling a fuel injection amount from the fuel injection device, and controlling the ignition timing of the ignition device such that a requested engine torque Te (hereinafter, a demand engine torque Tedem) is acquired, for example. The engine output control portion 72 calculates a demand drive force Fdem as a drive demand amount based on the actual accelerator operation amount θacc and vehicle speed V from a relationship (a drive force map) not depicted stored in advance between the vehicle speed V and the demand drive force Fdem by using the accelerator operation amount θacc as a parameter, for example, and calculates a demand engine torque Tedem at which the demand drive force Fdem is acquired, based on the gear ratio e at the current gear stage of the automatic transmission 16 etc. The drive demand amount can be implemented by using not only the demand drive force Fdem [N] at the wheels 20 but also a demand drive torque Touttgt [Nm] at the wheels 20, a demand drive power [W] at the wheels 20, a demand transmission output torque of the automatic transmission 16, a demand transmission input torque of the automatic transmission 16, and the demand engine torque Tedem. The drive demand amount can also be implemented by simply using the accelerator operation amount θacc [%], a throttle valve opening degree [%], an intake air amount [g/sec] of the engine 14, etc.

The shift control portion 74 provides the shift control of the automatic transmission 16. Specifically, the shift control portion 74 makes a shift determination based on a vehicle state indicated by the actual vehicle speed V and the drive demand amount from a known relationship (a shift map, a shift diagram) defined in advance and stored by using the vehicle speed V and the drive demand amount as variables. If it is determined that a shift of the automatic transmission 16 should be performed, the shift control portion 74 outputs to the hydraulic control device 32 the oil pressure command signal Sp for engaging and/or releasing the hydraulic friction engagement devices involved with the shift of the automatic transmission 16 such that the determined gear stage is achieved.

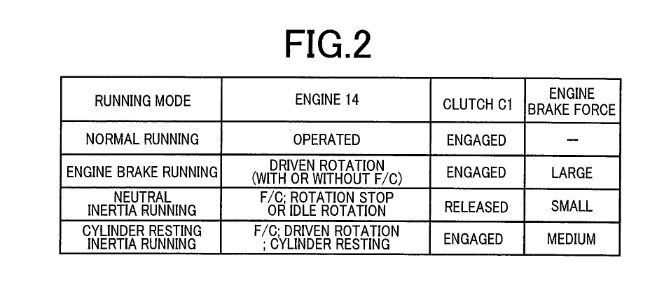

The engine output control portion 72 and the shift control portion 74, the engine brake running portion 76, the neutral inertia running portion 78, and the cylinder resting inertia running portion 80 perform four respective running modes depicted in FIG. 2. The engine output control portion 72 and the shift control portion 74 perform a normal running mode performed by using the power of the engine 14 with the engine 14 and the wheels 20 coupled (i.e., with the clutch C1 engaged). Specifically, as described above, the engine output control portion 72 provides the output control of the engine 14 such that the drive demand amount is acquired, and the shift control portion 74 provides the shift control of the automatic transmission 16 including engagement of the clutch C1 based on the vehicle state indicated by the actual vehicle speed V and the drive demand amount from the shift map.

The engine brake running portion 76 performs the engine brake running mode (also referred to as engine-braking) that is an inertia running mode performed with the engine 14 and the wheels 20 coupled without stopping the operation in the cylinders of the engine 14. This engine brake running mode is performed with the coupling state between the engine 14 and the wheels 20 maintained during accelerator-off, for example, and an engine brake is generated by a pumping loss, a friction torque, etc. from the driven rotation of the engine 14. Although the engine 14 may be supplied with a minimum amount of fuel as is the case with the idling state during accelerator-off, the engine 14 is controlled to be in a fuel cut state in which fuel supply to the engine 14 is stopped in this example. The automatic transmission 16 has a predetermined gear stage established depending on the vehicle speed V etc., and the clutch C1 is retained in the engaged state. As a result, the engine 14 is driven to rotate at a predetermined rotation speed defined depending on the vehicle speed V and the gear ratio e and the engine brake force of the magnitude corresponding to the rotation speed is generated.

The neutral inertia running portion 78 performs a neutral inertia running mode (also referred to as N-coasting) that is an inertia running mode performed with the engine 14 and the wheels 20 separated (i.e., with the clutch C1 released). In the neutral inertia running mode, the fuel supply to the engine 14 may be stopped to halt the rotation, or the engine 14 may be supplied with fuel and operated. Therefore, the engine 14 may be put into a state in which the rotation is stopped by performing a fuel cut F/C or may be put into an idling state for self-sustaining operation. Since the release of the clutch C1 results in the engine brake force of substantially zero in the neutral inertia running mode, a reduction in running resistance extends the running distance of the inertia running mode, and fuel consumption can be improved. Although fuel is consumed if the engine 14 is operated in the idling state, since the distance of the inertia running mode becomes longer as compared to the engine brake running mode, a frequency of reacceleration is reduced and overall fuel consumption is improved. If the fuel cut F/C of the engine 14 is performed, the mechanical oil pump 34 is not driven and, therefore, the electric oil pump 36 is operated for controlling the clutch engagement oil pressure to the clutch C1 etc.

The cylinder resting inertia running portion 80 performs the cylinder resting inertia running mode (also referred to as cylinder resting coasting) that is inertia running mode performed by stopping operation in at least some of the cylinders of the engine 14 while the engine 14 and the wheels 20 are coupled. In the cylinder resting inertia running mode, while the engaged state of the clutch C1 is maintained to couple the engine 14 and the wheels 20, the fuel supply to the engine 14 is stopped (the fuel cut F/C is performed), and the cylinder resting device of the engine control device 30 stops the operation of the intake/exhaust valves of at least some of the cylinders of the engine 14 at the positions where all the valves are in the closed valve state. In this case, since the intake/exhaust valves are stopped in the closed valve state although the crankshaft is driven to rotate depending on the vehicle speed V and the gear stage of the automatic transmission 16, a loss due to a pumping action becomes smaller as compared to the case of opening/closing in synchronization with the crankshaft, and the engine brake force is reduced as compared to the engine brake running mode. As a result, the running distance of the inertia running mode is extended and the fuel consumption is improved. Although the engine brake force is larger as compared to the neutral inertia running mode and the running distance of the inertia running mode becomes relatively short in the cylinder resting inertia running mode, the engine 14 is subjected to the fuel cut and simply driven to rotate and, therefore, the efficiency of fuel consumption is on the same level with, or equal to or greater than, the neutral inertia running mode when the engine 14 is operated in the idling state.

The running mode determining portion 82 determines any one mode for the running of the vehicle from the four running modes, i.e., the normal running mode, the engine brake running mode, the neutral inertia running mode, and the cylinder resting inertia running mode, and switches to the determined running mode or determines which mode the vehicle is actually running in. Specifically, for example, during accelerator-on when the accelerator operation amount θacc is not determined as zero, the running mode determining portion 82 basically determines to perform the normal running mode. On the other hand, for example, if the accelerator is continuously turned off for a predetermined time or longer during the normal running mode, the running mode determining portion 82 determines to perform the engine brake running mode, the neutral inertia running mode, or the cylinder resting inertia running mode based on predefined inertia running conditions. The inertia running conditions are defined in advance such that the engine brake running mode, the neutral inertia running mode, or the cylinder resting inertia running mode are performed by using classification according to the vehicle speed V, a brake operation force, a steering angle, a running road, and a situation of another vehicle, for example. For example, it is defined in advance that the neutral inertia running mode or the cylinder resting inertia running mode are performed in a region where the brake operation force is small and that the engine brake running mode are in a region where the brake operation force is large, respectively. The conditions are defined in advance such that the execution of the neutral inertia running mode is facilitated as compared to the cylinder resting inertia running mode when the running road is a flat road or a gentle downslope, when the vehicle is running straight, when a preceding vehicle is absent, or when an inter-vehicle distance to a preceding vehicle is equal to or greater than a predetermined inter-vehicle distance. Although the conditions may be defined in advance such that the fuel cut F/C having a high fuel consumption improvement effect is basically performed in the neutral inertia running mode, the conditions may be defined in advance such that the engine 14 is put into the idling state if the engine 14 must be warmed up, if a battery must be charged by the power of the engine 14, or if the mechanical oil pump 34 must be driven by the power of the engine 14.

If a canceling condition for canceling the inertia running mode is satisfied during the engine brake running mode, the neutral inertia running mode, or the cylinder resting inertia running mode, the running mode determining portion 82 cancels the inertia running mode and determines to switch to another running. The canceling condition is a predetermined return condition for returning to the normal running mode, which is an increase in the drive demand amount (e.g., accelerator-on), for example. If the predetermined return condition is satisfied, the running mode determining portion 82 determines to return to the normal running mode. Alternatively, the canceling condition is a predetermined shift condition for shifting to the engine brake running mode such as a brake operation force equal to or greater than a predetermined brake operation force, a steering angle equal to or greater than a predetermined steering angle, or an inter-vehicle distance equal to or greater than a predetermined inter-vehicle distance during the neutral inertia running mode or during the cylinder resting inertia running mode. If the predetermined shift condition is satisfied, the running mode determining portion 82 determines to shift to the engine brake running mode.

The running mode determining portion 82 determines the running mode of the actual running being performed out of the normal running mode, the engine brake running mode, the neutral inertia running mode, and the cylinder resting inertia running mode, based on a state of the engine 14 and a state of the clutch C1 as depicted in FIG. 2, for example. Alternatively, if a flag indicative of the running mode is defined in advance, the running mode determining portion 82 may determine the running mode of the actual running being performed based on the actual flag.

While a step of engaging the clutch C1 is included in the case of return from the neutral inertia running mode to the normal running mode, the step is not included in the case of return from the cylinder resting inertia running mode to the normal running mode since the clutch C1 is originally engaged. Therefore, the power of the engine 14 can promptly be transmitted toward the wheels 20 to output the drive force at the time of return from the cylinder resting inertia running mode as compared to the time of return from the neutral inertia running mode. Although a larger line pressure in the hydraulic control device 32 enables generation of a clutch torque required for transmitting a larger power, a time lag exists before the actual line pressure increases as commanded by the oil pressure command signal Sp. On the other hand, a large line pressure deteriorates the controllability of the clutch engagement pressure when the clutch C1 is controlled toward engagement and sudden engagement may increase an engagement shock. Additionally, a certain time is required for engaging the clutch C1 from a released state. On the other hand, if a clutch torque appropriate for a torque amount transmitted toward the wheels 20 is ensured at the time of completion of the engagement of the clutch C1, no clutch slip occurs. Therefore, even when the line pressure is lowered during the neutral inertia running mode, the line pressure can sufficiently be raised to increase the clutch torque before the clutch C1 is engaged, a clutch slip hardly occurs after completion of the engagement of the clutch C1. From the above, the line pressure during the inertia running mode is desirably set in consideration of the line pressure required at the time of return. From another view point, since the engine rotation speed Ne during the cylinder resting inertia running mode is the same as that during the normal running mode, it is considered that a driver expects the acceleration performance at the time of return same as that of the normal running mode. On the other hand, since the engine rotation speed Ne during the neutral inertia running mode is lowered as compared to the normal running mode, it is considered that a driver does not expect the acceleration performance at the time of return comparable to that during the normal running mode. Therefore, unless the line pressure during the inertia running mode is set with consideration given to the difference between the respective procedures at the time of return from the two types of the inertia running modes, i.e., the neutral inertia running mode and the cylinder resting inertia running mode, and the characteristics of the oil pressure related to the control of the clutch C1, a desired drive force becomes difficult to acquire or the engagement shock of the clutch C1 is deteriorated at the time of return from the inertia running mode, and a driver may more easily have a feeling of strangeness.

Therefore, the electronic control device 70 sets the line pressure in preparation for return to the normal running mode during the neutral inertia running mode and the cylinder resting inertia running mode. Specifically, the shift control portion 74 sets the line pressure lower while the neutral inertia running mode is performed as compared to while the cylinder resting inertia running mode is performed. For example, during the neutral inertia running mode, the shift control portion 74 outputs to the hydraulic control device 32 the oil pressure command signal Sp setting the line pressure to a line pressure smallest value defined in advance as a requisite minimum line pressure. During the cylinder resting inertia running mode, the shift control portion 74 outputs to the hydraulic control device 32 the oil pressure command signal Sp setting the line pressure to a line predetermined value defined in advance as a line pressure for preventing the clutch C1 from slipping at the time of return.

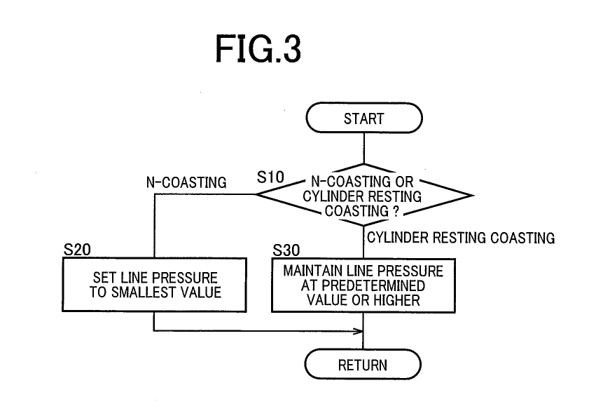

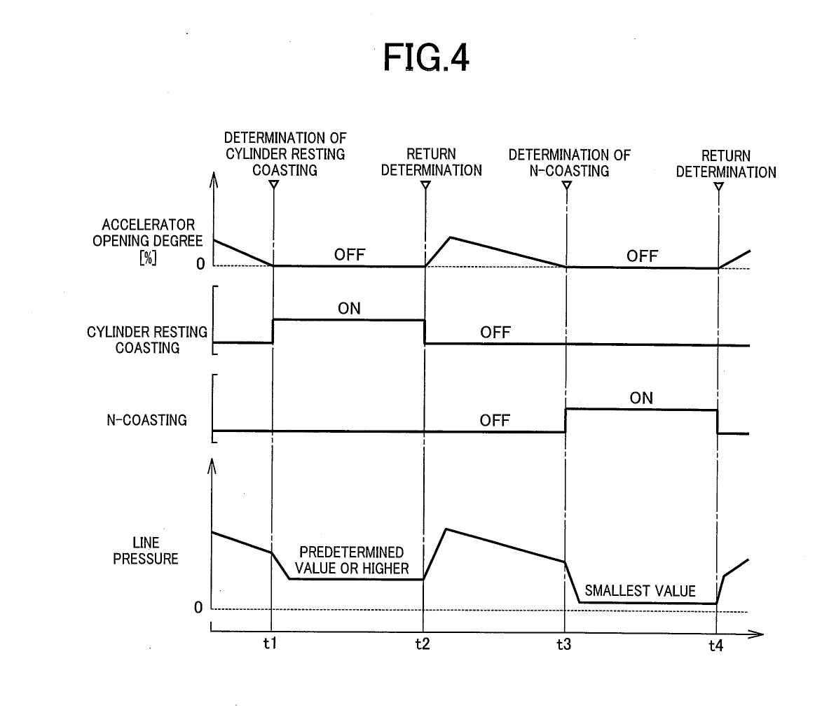

FIG. 3 is a flowchart for explaining a main portion of the control operation of the electronic control device 70, i.e., the control operation for preventing a driver from having a feeling of strangeness at the time of return from the respective different types of the inertia running modes, which are the neutral inertia running mode and the cylinder resting inertia running mode, and is repeatedly executed with an extremely short cycle time, for example, on the order of a few msec to a few tens of msec. The flowchart of FIG. 3 is based on the assumption that the inertia running mode is performed because the accelerator is turned off during the normal running mode. FIG. 4 is a time chart when the control operation depicted in the flowchart of FIG. 3 is executed.

In FIG. 3, first, at step (hereinafter, step will be omitted) S10 corresponding to the running mode determining portion 82, the running mode of actual inertia running mode being performed is determined out of the neutral inertia running mode and the cylinder resting inertia running mode, for example. If it is determined at S10 that the running mode is the neutral inertia running mode, for example, the line pressure is set to the predefined line pressure smallest value at S20 corresponding to the shift control portion 74 (time t3 to time t4 of FIG. 4). On the other hand, if it is determined at S10 that the running mode is the cylinder resting inertia running mode, for example, the line pressure is maintained at the predefined line predetermined value or higher at S30 corresponding to the shift control portion 74 (time t1 to time t2 of FIG. 4).

In FIG. 4, if the cylinder resting inertia running mode is determined in association with accelerator-off during the normal running mode (time t1), the cylinder resting inertia running mode is performed. The line pressure is maintained at the predefined line predetermined value during the cylinder resting inertia running mode (time t1 to time t2). If a return determination (time t2) is made in association with accelerator-on, a return to the normal running mode is performed. If the neutral inertia running mode is determined in association with accelerator-off during the normal running mode (time t3), the neutral inertia running mode is performed. The line pressure is maintained at the predefined line pressure smallest value during the neutral inertia running mode (time t3 to time t4). If a return determination (time t4) is made in association with accelerator-on, a return to the normal running mode is performed. Because of the interposition of the engagement control of the clutch C1 at the time of return from the neutral inertia running mode, the line pressure can sufficiently be raised before completion of the engagement of the clutch C1 after the return. Therefore, during the neutral inertia running mode, the line pressure is lowered to put more importance on fuel consumption, thereby reducing a loss due to the oil pumps (the mechanical oil pump 34 and the electric oil pump 36). On the other hand, since the engagement control of the clutch C1 is not included at the time of return from the cylinder resting inertia running mode, the line pressure for ensuring the clutch torque is required so that a large drive force can be transmitted from the initial stage of acceleration after the return. Therefore, during the cylinder resting inertia running mode, the line pressure is maintained at a predetermined value or higher to prevent a slip of the clutch C1 while ensuring the acceleration responsiveness at the time of return. Since the line pressure is controlled in accordance with the characteristics of the inertia running mode as described above, the improvement in fuel consumption and the prevention of clutch slipping during acceleration can be satisfied at the same time.

As described above, according to this example, the line pressure is lowered during the neutral inertia running mode so as to ensure the controllability of the clutch engagement pressure supplied to the clutch C1 when the clutch C1 is controlled toward engagement at the time of return, and the engagement shock is suppressed. On the other hand, the line pressure can be made higher during the cylinder resting inertia running mode to raise the clutch torque of the clutch C1 and, even if a large power is immediately transmitted at the time of return, the clutch slipping of the clutch C1 can be prevented. Additionally, the clutch torque of the clutch C1 can be increased during the cylinder resting inertia running mode to promptly output the drive force at the time of return and to respond to the driver's expectation. Contrarily, since the engine rotation speed Ne is lowered during the neutral inertia running mode as compared to the normal running mode, a driver hardly has a feeling of strangeness even if the acceleration performance is different from that during the normal running mode. Therefore, the driver can be prevented from having a feeling of strangeness at the time of return from the respective different types of the inertia running modes, which are the neutral inertia running mode and the cylinder resting inertia running mode.

According to this example, since the neutral inertia running mode is an inertia running mode with the rotation of the engine 14 stopped by the fuel cut F/C, or the inertia running mode with the engine 14 operated in the idling state, while the engine 14 and the wheels 20 are separated, the engagement shock of the clutch C1 at the time of return is suppressed by lowering the line pressure during the neutral inertia running mode regardless of the presence/absence of the fuel supply to the engine 14.

Another example of the present invention will be described. In the following description, the portions mutually common to the examples are denoted by the same reference numerals and will not be described.

### Second Example

In the first example, the neutral inertia running mode and the cylinder resting inertia running mode are taken up as the different types of the inertia running modes in which the line pressure is properly controlled in preparation of the time of return. Since the inertia running mode also includes the engine brake running mode, the engine brake running mode is taken up in this example. Since the operation in the cylinders of the engine 14 is not stopped by the cylinder resting device of the engine control device 30, the power of the engine 14 can more promptly be transmitted toward the wheels 20 to output the drive force in the engine brake running mode as compared to the cylinder resting inertia running mode. Since the engine rotation speed Ne during the engine brake running mode is the same as that during the normal running mode as is the case with the cylinder resting inertia running mode, it is considered that a driver expects the acceleration performance at the time of return same as that of the normal running mode.

Therefore, in this example, the electronic control device 70 sets the line pressure also for the engine brake running mode in preparation for returning to the normal running mode in addition to the first example. Specifically, the shift control portion 74 sets the line pressure higher while the engine brake running mode is performed as compared to while the cylinder resting inertia running mode is performed. For example, during the engine brake running mode, the shift control portion 74 outputs to the hydraulic control device 32 the oil pressure command signal Sp setting the line pressure to a value acquired by adding, to the predefined line predetermined value that is the line pressure during the cylinder resting inertia running mode, an increment α defined in advance as a line pressure increment for preventing the clutch C1 from slipping at the time of return corresponding to the absence of the resting of the cylinders (=line predetermined value+α), in addition to the first example.

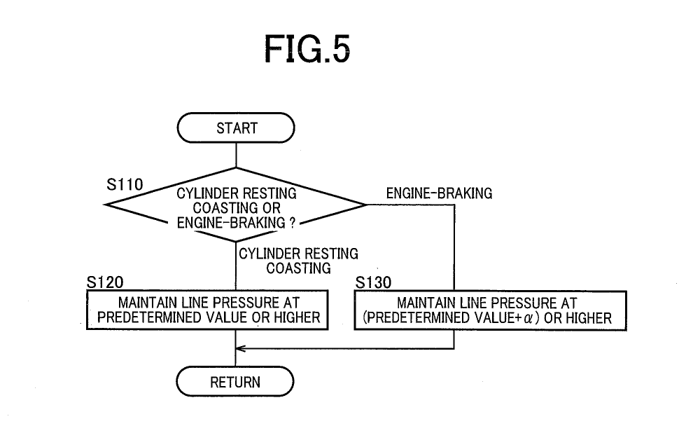

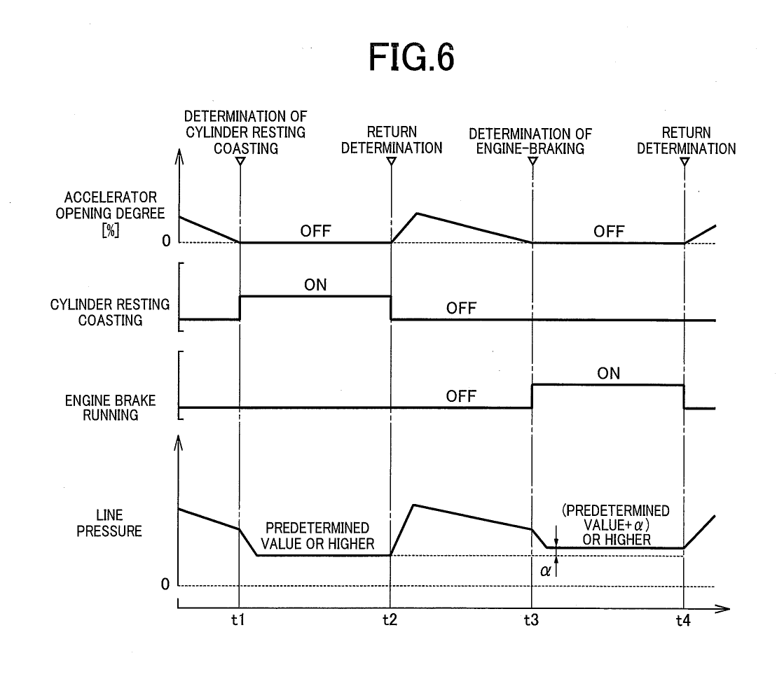

FIG. 5 is a flowchart for explaining a main portion of the control operation of the electronic control device 70, i.e., the control operation for preventing a driver from having a feeling of strangeness at the time of return from the respective different types of the inertia running modes, and is repeatedly executed with an extremely short cycle time, for example, on the order of a few msec to a few tens of msec. The flowchart of FIG. 5 is executed in addition to the flowchart of FIG. 3. FIG. 6 is a time chart when the control operation depicted in the flowchart of FIG. 5 is executed.

In FIG. 5, first, at step (hereinafter, step will be omitted) S110 corresponding to the running mode determining portion 82, the running mode of actual inertia running mode being performed is determined out of the cylinder resting inertia running mode and the engine brake running mode, for example. If it is determined at S110 that the running mode is the cylinder resting inertia running mode, for example, the line pressure is maintained at the predefined line predetermined value or higher at S120 corresponding to the shift control portion 74 (time t1 to time t2 of FIG. 6). On the other hand, if it is determined at S110 that the miming mode is the engine brake running mode, for example, the line pressure is maintained at the predefined (line predetermined value+α) or higher at S130 corresponding to the shift control portion 74 (time t3 to time t4 of FIG. 6).

In FIG. 6, if the cylinder resting inertia running mode is determined in association with accelerator-off during the normal running mode (time t1), the cylinder resting inertia running mode is performed. The line pressure is maintained at the predefined line predetermined value during the cylinder resting inertia running mode (time t1 to time t2). If a return determination (time t2) is made in association with accelerator-on, a return to the normal running mode is performed. If the engine brake running mode is determined in association with accelerator-off during the normal running mode (time t3), the engine brake running mode is performed. The line pressure is maintained at the predefined (line predetermined value+α) during the engine brake running mode (time t3 to time t4). If a return determination (time t4) is made in association with accelerator-on, a return to the normal running mode is performed.

As described above, according to this example, the line pressure can be made higher during the engine brake running mode as compared to the cylinder resting inertia running mode to prevent the clutch slipping of the clutch C1 even if a large power is immediately transmitted at the time of return, as is the case with the return from the cylinder resting inertia running mode. Additionally, the clutch torque of the clutch C1 can be increased during the engine brake running mode as compared to the cylinder resting inertia running mode to promptly output the drive force at the time of return and to respond to the driver's expectation, as is the case with the return from the cylinder resting inertia running mode. Therefore, the driver can be prevented from having a feeling of strangeness also at the time of return from the engine brake running mode, as is the case with the different types of the inertia running modes, which are the neutral inertia running mode and the cylinder resting inertia running mode.

Although the examples of the present invention have been described in detail with reference to the drawings, the present invention can be implemented by combining the examples with each other and is also applied in other forms.

For example, although the clutch C1 making up a portion of the automatic transmission 16 is exemplified as the clutch separating the engine 14 and the wheels 20 in the examples, this is not a limitation. For example, the clutch C1 may be disposed independently of the automatic transmission 16. If the automatic transmission 16 is, for example, a belt type continuously variable transmission, the clutch C1 is disposed independently of the continuously variable transmission, and the clutch may be an engagement device included in a known forward/backward switching device included in the vehicle along with the belt type continuously variable transmission. The present invention is applicable to a vehicle without a transmission.

Although the line pressure during the neutral inertia running mode is the predefined line pressure smallest value in the examples, this is not a limitation and, for example, the line pressure only needs to be smaller than the predefined line predetermined value that is the line pressure during the cylinder resting inertia running mode. A certain effect of the present invention is also acquired in this way.

Although the vehicle 10 has the mechanical oil pump 34 and the electric oil pump 36 disposed as the oil pumps in the examples, this is not a limitation. For example, only the electric oil pump 36 may be disposed. Alternatively, if a form of stopping the rotation of the engine 14 by the fuel cut F/C is not employed in the neutral inertia running mode, only the mechanical oil pump 34 may be disposed and the electric oil pump 36 may not be disposed.

The above description is merely an embodiment and the present invention can be implemented in variously modified and improved forms based on the knowledge of those skilled in the art.

### NOMENCLATURE OF ELEMENTS

10: vehicle 14: engine 20: wheels 34: mechanical oil pump (oil pump) 36: electric oil pump (oil pump) 70: electronic control device (running control device) C1: clutch

1. A running control device of a vehicle including an engine with a plurality of cylinders and a clutch separating the engine and wheels, the running control device of a vehicle controlling and supplying to the clutch a line pressure acquired by adjusting an output oil pressure of an oil pump, the running control device of a vehicle being configured to execute a neutral inertia running mode that is an inertia running mode performed while the engine and the wheels are separated and a cylinder resting inertia running mode performed by stopping operation in at least a part of the cylinders of the engine while the engine and the wheels are coupled,
the line pressure being low while the neutral inertia running mode is performed as compared to while the cylinder resting inertia running mode is performed.

2. The running control device of a vehicle of claim 1, wherein
the running control device of a vehicle is configured to execute an engine brake running mode that is an inertia running mode performed without stopping operation in the cylinders of the engine while the engine and the wheels are coupled, and wherein
the line pressure is high while the engine brake running is performed as compared to while the cylinder resting inertia running mode is performed.

3. The running control device of a vehicle of claim 1, wherein the cylinder resting inertia running mode is an inertia running mode performed by stopping fuel supply to the engine while the engine and the wheels are coupled and by stopping operation of at least one of pistons and intake/exhaust valves of at least a part of the cylinders of the engine.

4. The running control device of a vehicle of claim 1, wherein the neutral inertia running mode is an inertia running mode performed with fuel supply to the engine stopped to stop rotation, or an inertia running mode performed with the engine supplied with fuel and operated, while the engine and the wheels are separated.
